(19) United States
(12) Patent Application Publication
(10) Pub. No.: US 2010/0281092 A1
(43) Pub. Date: Nov. 4, 2010

(54) STANDARD CELL FOR ARITHMETIC LOGIC UNIT AND CHIP CARD CONTROLLER

(76) Inventor: Thomas Kuenemund, Munich (DE)

Correspondence Address: INFINEON TECHNOLOGIES AG;Patent Department, MUC 11.1.507, P.O. Box 221644, Munich, 80506, DE

(21) Appl. No.: 12/770,833

(22) Filed: Apr. 30, 2010

Related U.S. Application Data
(63) Continuation-in-part of application No. 11/501,305, filed on Aug. 9, 2006.
Application No. 11/501,305 is a continuation-in-part of application No. 11/890,966, filed on Aug. 8, 2007.

(51) Int. Cl. G06F 7/38

(52) U.S. Cl. 708/490

(57) ABSTRACT

A masked ALU cell for a certain bit position p is provided. The cell comprises a base unit operable to generate a masked inverted carry out bit co*_n and an inverted masked sum bit s*_n based on a first masked output a*, a second masked output b*, and a re-masked carry bit input ci*; a transformation unit coupled to the base unit, the transformation unit having a first masked input bit aₖₐ, a second masked input bit b_{kb}, a first mask input bit ka, a second mask input bit kb, a third mask input bit ks, and a fourth mask input bit kp, wherein the transformation unit is operable to generate the first masked output a* based on the first masked input bit aₖₐ, the first mask input bit ka, and the fourth mask input bit kp; the second masked output b* based on the second masked input bit b_{kb}, the second mask input bit kb, and fourth mask input bit kp; and a masked sum bit sₖₛ based on the third mask input bit ks, the inverted masked sum bit s*_n, and the fourth mask input bit kp.

This application is a continuation-in-part of application Ser. No. 11/501,305, filed Aug. 9, 2006, and of application Ser. No. 11/890,966, filed Aug. 8, 2007, both entitled STANDARD CELL FOR ARITHMETIC LOGIC UNIT AND CHIP CARD CONTROLLER, the entirety of which is hereby incorporated by reference.

### BACKGROUND INFORMATION

The present invention relates generally to processors and controllers and standard cells for arithmetic logic units (ALUs) in such processors and controllers.

A standard cell for ALUs in microcontrollers may be implemented using a semi-custom design style. Chip card controllers have to meet high requirements in terms of resistance to invasive probing and/or non-invasive differential power analysis (DPA) of security-critical information. One prior art device uses bitwise XOR masking of all data using time-variant masks, so-called “one-time pad (OTP)” masks.

FIG. 1 shows a so-called “mirror adder”, a conventional full adder cell 10 which implements the equations

co_{—}n= a̅·̅b̅+̅b̅·̅c̅i̅+̅c̅i̅·̅a̅ (1)

s_n=a⊕b⊕ci (2).

The mirror adder thus logically combines the two operand bits a and b and the carry-in bit ci in order to obtain the inverted carry-out bit co_n and the inverted sum bit s_n. In a standard-cell implementation of the mirror adder, co_n and s_n are usually additionally inverted by two inverters, respectively, one per output, such that the outputs of the mirror adder cell are usually the carry bit co and the sum bit s.

When output signals produced by a conventional full adder are supplied with masked input data, the equations

y=a·b+b·c+c·a (3)

z=a⊕b⊕c (4)

are transformed under the “masking operation”, that is, the XOR combination

\hat{x}=x⊕k (5)

of x=a, b and c with an OTP bit k.
One then obtains

â·\hat{b}+\hat{b}·ĉ+ĉ·â=(a·b+b·c+c·a)⊕k=y⊕k=ŷ

and â⊕\hat{b}⊕ĉ=a⊕b⊕c⊕k=z⊕k=\hat{z}. The “full adder equations” are form-invariant (covariant) under the “masking operation”: from input data masked with k, the full adder computes output data which is also obtained when output data from unmasked input data is masked with k.

### BRIEF DESCRIPTION OF THE DRAWINGS

FIG. 1 shows a prior art mirror adder.

The present invention will be described with respect to a preferred embodiment, in which:

FIG. 2 shows a masked mirror ALU datapath according to the present invention;

FIG. 3 shows ALU control circuitry for the masked mirror ALU datapath of FIG. 2;

FIG. 4 shows a masked mirror ALU I/O transformation circuitry for the ALU control circuitry of FIG. 3 and the masked mirror ALU datapath of FIG. 2;

FIG. 5 shows the controlled cell and the interaction of the transformation circuitry of FIG. 4 with the control circuitry of FIG. 3 and the ALU datapath of FIG. 2;

FIG. 6 shows a possible implementation for the XNOR3 gate of FIGS. 3; and

FIG. 7 shows ALU control logic circuitry without masking.

### DETAILED DESCRIPTION

Attempts to implement OTP masked ALU's using conventional standard cells have led to unacceptable values for the computing speed and energy expenditure. Because of this, commercial implementation of OTP-masked computation has been difficult.

In one embodiment the present disclosure provides a cell for arithmetic logic unit comprising a base unit operable to generate a masked inverted carry out bit co*_n and an inverted masked sum bit s*_n based on a first masked output a*, a second masked output b*, and a re-masked carry bit input ci*; a transformation unit coupled to the base unit, the transformation unit having a first masked input bit aₖₐ, a second masked input bit b_{kb}, a first mask input bit ka, a second mask input bit kb, a third mask input bit ks, and a fourth mask input bit kp, wherein the transformation unit is operable to generate the first masked output a* based on the first masked input bit aₖₐ, the first mask input bit ka, and the fourth mask input bit kp; the second masked output b* based on the second masked input bit b_{kb}, the second mask input bit kb, and fourth mask input bit kp; and a masked sum bit sₖ, based on the third mask input bit ks, the inverted masked sum bit s*_n, and the fourth mask input bit kp.

In another embodiment, the present disclosure provides a transformation unit in an arithmetic logic unit cell comprising a first logic unit logically combining a first masked input bit aₖₐ with a mask input bit ka for the first masked input bit and a mask input bit for a certain bit position kp to form a first masked output a*; a second logic unit logically combining a second masked input bit b_{kb} with the mask input bit for a certain bit position kp and a mask input bit kb for the second masked input bit to form a second masked output b*; and a third logic unit logically combining an inverted masked sum bit s*_n with the mask input bit kp for a certain bit position and a mask input bit ks for the masked sum bit to form a masked sum bit sₖₛ

In yet another embodiment, the present disclosure provides a cell of an arithmetic logic unit of a certain bit position p comprising a control circuit being operable to receive a re-masked carry bit input ci*, a set of control inputs xe0, xe1 generated based on a mask input bit kp for a certain bit position, a mask input bit kp-1 for a previous bit position, a masked carry input bit ci*, a set of control signals n0, n1; a base circuit coupled to the control circuit, the base circuit being operable to receive a set of masked outputs a*, b*, and the re-masked carry bit input ci* and to generate an inverted masked carry out bit co*_n and an inverted masked sum bit s*_n; and a transformation circuit coupled to the base circuit, the transformation circuit logically combining a set of masked inputs aₖₐ, b_{kb} and the inverted masked sum bit s*_n with a corresponding set of mask input bits ka, kb, ks and the mask input bit kp for a certain bit position.

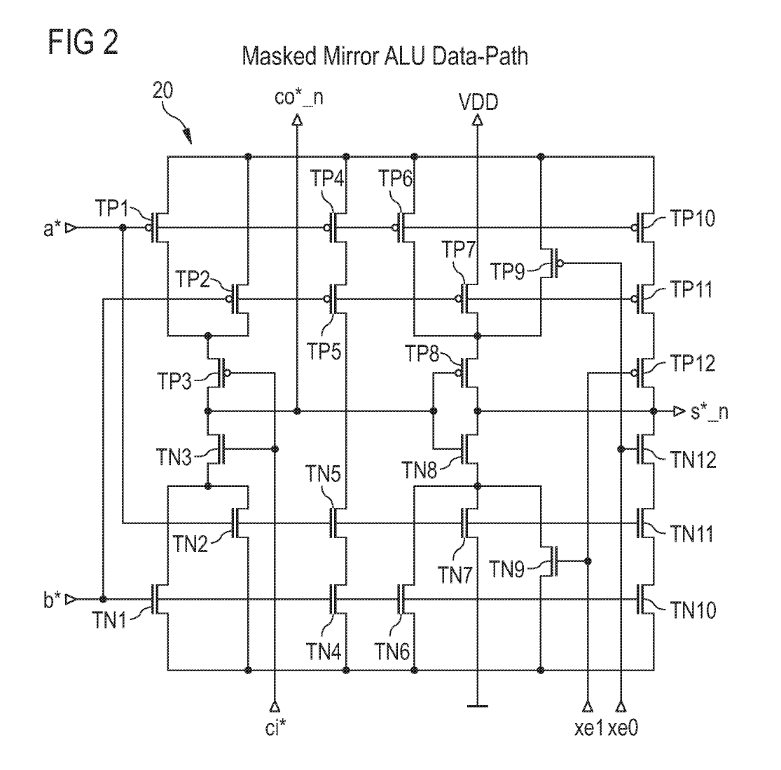

FIG. 2 shows a possible mirror ALU datapath implementation 20 in CMOS according to the present invention, with transistors TP1 to TP12 and TN1 to TN12. According to a feature of the present invention, rather than being connected to the carry-in bit ci, as in the prior art, the transistors TN9 and TP12 are connected to an input control signal xe1; and transistors TN12 and TP9 are connected to an input control signal xe0.

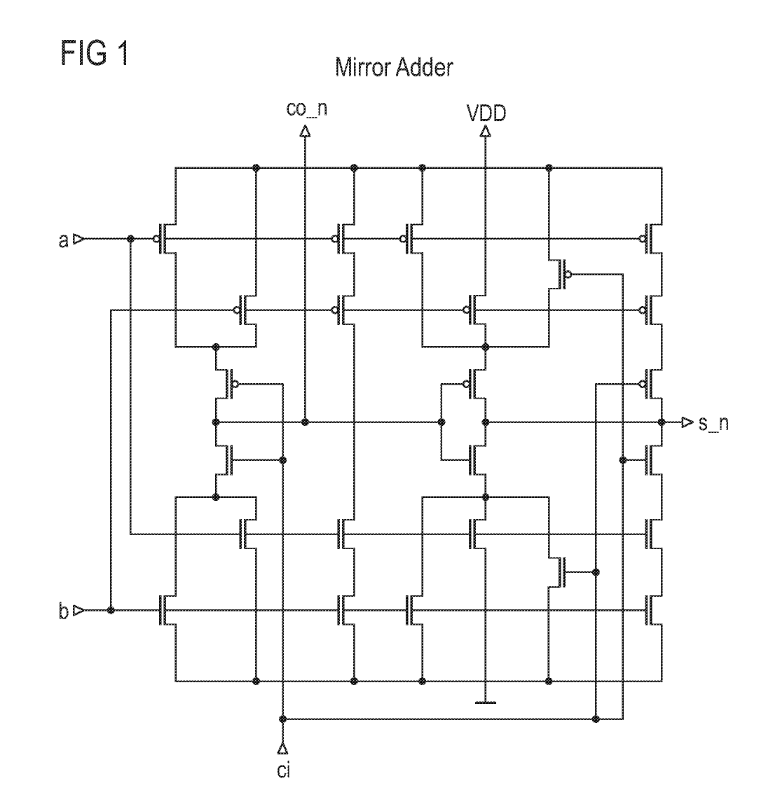

From this, it follows that the relationship between co*_n and a*, b* and ci* in FIG. 2 is the same as that between co_n and a, b, and ci in FIG. 1:

co*_{—}n= a̅*̅·̅b̅*̅+̅b̅*̅·̅c̅i̅*̅+̅c̅i̅*̅·̅a̅*̅ (6)

and, secondly, that the equation for s*_n in FIG. 2 is:

s*_n= a̅*̅⊕̅b̅*̅⊕̅c̅i̅*̅ (7)

when xe1=xe0=ci*,
and, respectively,

s*_{—}n= c̅o̅*̅_̅{̅—̅}̅n̅=a*·*b*+b*·*ci*+ci*·a* (8)

for xe1=1, xe0=0

Other values for xe1 and xe0 are not needed in this embodiment.

With the definition

y*=y⊕kₚ, (9)

(where kₚ denotes the mask bit for bit position p) for masked data, it follows from the covariance of the full adder equations under the masking operation, first of all, that the circuit specified in FIG. 2 has the properties required for calculating (6) the masked carry-out co*_n from the masked inputs a*, b* and ci*.

As for the inverted sum bit s*_n, i.e., the equations (7) and (8), (7) represents the conventional (covariant) full adder equation for the inverted sum bit if ci* denotes the carry bit masked with kₚ of bit position p. However, if it is provided that the carry-in bit ci* for bit position p is set to the inverse to mask bit kₚ ( k̅ₚ̅), it follows that (7) implements the kₚ-masked XNOR operations on a* and b*:

s*_n= a̅*̅⊕̅b̅*̅⊕̅ k̅ ₚ̅=a*⊕b*⊕kₚ

for ci*= k̅ₚ̅.

Alternatively to equation (7), or to the ADD, and XNOR operations, as described above, the operations NAND and NOR can be implemented by (8). To this end, in addition to the conditions xe1=1, xe0=0 for the validity of (8), it should again be provided that the carry-in bit ci* for bit position p is equal to mask bit kₚ or to its inverse k̅ₚ̅, respectively. If so, it follows that (8) implements the kₚ-masked NAND and NOR operations on a* and b*, respectively:

$$\begin{matrix}{s}^{*} \_n = {a}^{*} \cdot {b}^{*} + ( {a}^{*} + {b}^{*} ) \cdot {ci}^{*} = \\ = ( a ⊕ {k}_{p} ) \cdot ( b ⊕ {k}_{p} ) + ( a ⊕ {k}_{p} + b ⊕ {k}_{p} ) \cdot {k}_{p} = \\ = a \cdot b \cdot \overline{{k}_{p}} + \overline{a \cdot b} \cdot {k}_{p} = \\ = ( a \cdot b ) ⊕ {k}_{p} = \\ = {( a \cdot b )}^{*}\end{matrix}$$

for ci*=kₚ, and, respectively,

$$\begin{matrix}{s}^{*} \_n = {a}^{*} \cdot {b}^{*} + ( {a}^{*} + {b}^{*} ) \cdot {ci}^{*} = \\ = ( a ⊕ {k}_{p} ) \cdot ( b ⊕ {k}_{p} ) + ( a ⊕ {k}_{p} + b ⊕ {k}_{p} ) \cdot \overline{{k}_{p}} = \\ = ( a + b ) \cdot \overline{{k}_{p}} + \overline{a + b} \cdot {k}_{p} = \\ = ( a + b ) ⊕ {k}_{p} = \\ = {( a + b )}^{*}\end{matrix}$$

for ci*= k̅ₚ̅.

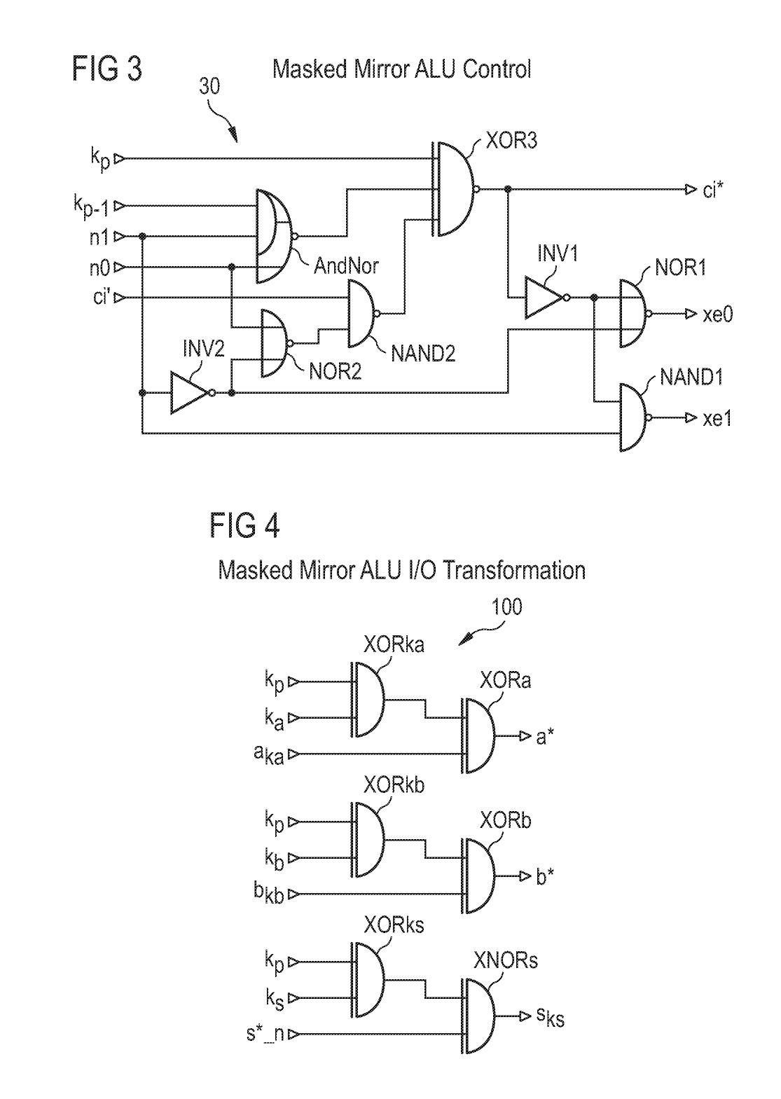

FIG. 3 shows a control circuit 30 by which the value combinations for xe1, xe0 and ci* specified above for the implementation of the various operations can be generated as a function of the mask bits kₚ (of the bit position p associated with the currently considered ALU cell) and kₚ₋₁, (of the bit position p-1 whose carry-out bit coₚ₋₁ represents the carry-in bit of bit position p), the carry-in bit ci′ and the control signals n1 and n0.

The following table summarizes the generation of xe1, xe0 and ci*:

| n1 | n0 | Ci*ₚ | xe1 | xe0 | Operation | s*_n |
|---|---|---|---|---|---|---|
| 1 | 0 | ci′⊕kₚ₋₁ ⊕ kₚ | ci*ₚ | ci*ₚ | ADD | a̅*̅ ⊕̅b̅*̅ ⊕̅c̅i̅*̅ |
| 1 | 1 | k̅ _{p̅} | ci*ₚ | ci*ₚ | XNOR | (a ⊕ b)* |
| 0 | 0 | kₚ | 1 | 0 | NAND | (a · b)* |
| 0 | 1 | k̅ _{p̅} | 1 | 0 | NOR | (a + b)* |

FIG. 4 shows a masked mirror ALU I/O transformation circuit 100 for the masked mirror ALU datapath of FIG. 2. The transformation circuit 100 transforms the input operands (aₖₐ and b_{kb}, i.e., plain text operands a and b masked with independent masks ka and kb) and the output operands (sₖₛ i.e., plain text output s masked with another mask ks which is independent of ka and kb) to the mask kₚ which is valid for the given bit position for transmission data ci* and co*. The transformation circuit 100 performs the following operations:

a*=kₚ⊕ka⊕aₖₐ=a⊕kₚ

b*=kₚ⊕kb⊕b_{kb}=b⊕kₚ

sₖₛ= k̅_̅{̅p̅⊕̅k̅s̅}̅⊕̅s̅*̅_̅n̅=s⊕ks

where it is assumed that, as mentioned above

aₖₐ=a⊕ka

b_{kb}=b⊕kb

sₖₛ=s⊕ks

the plain text values masked with independent masks ka, kb and ks stand for a, b and s.

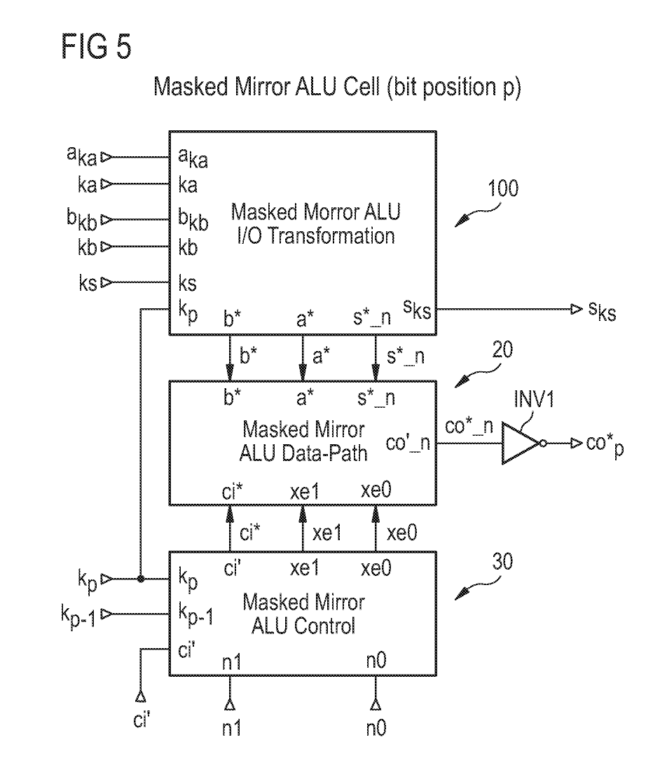

FIG. 5 shows the interconnection of the subcircuits 20, 30, 100 shown in FIGS. 2, 3 and 4 of the masked mirror ALU cell of the present invention and the generation of co*= c̅o̅*̅_̅n̅, by means of an inverter. The value co* n is input to an inverter 40 to generate the carry bit co*ₚ for the next downstream cell, so that co*ₚ becomes ci' for the next cell. Using only one mask (kᵣ) for all operands of one bit position (a*, b*, ci*, co*, s*) is limited to the interior of the circuit, i.e., only to subcircuit 20, which is just a few μm² in size, and its interfaces (for which it is also easy to ensure “spyproof” wiring of (a*, b*, ci*, co*, s*)).

All circuit elements included in FIG. 5 or its subfigures can be integrated physically (in the layout) into one unit, in an extension of conventional standard cell libraries. This, together with the minimal number of transistors and the small number and small electrical capacitance of the switching nodes, is the reason for the high computing speed and the low energy expenditure of this cell. The masked ALU cell may allow the possibility transforming, within the masked ALU cell, ka and kb with kₚ respectively and kₚ with ks and in the smallest space without a loss of processing speed.

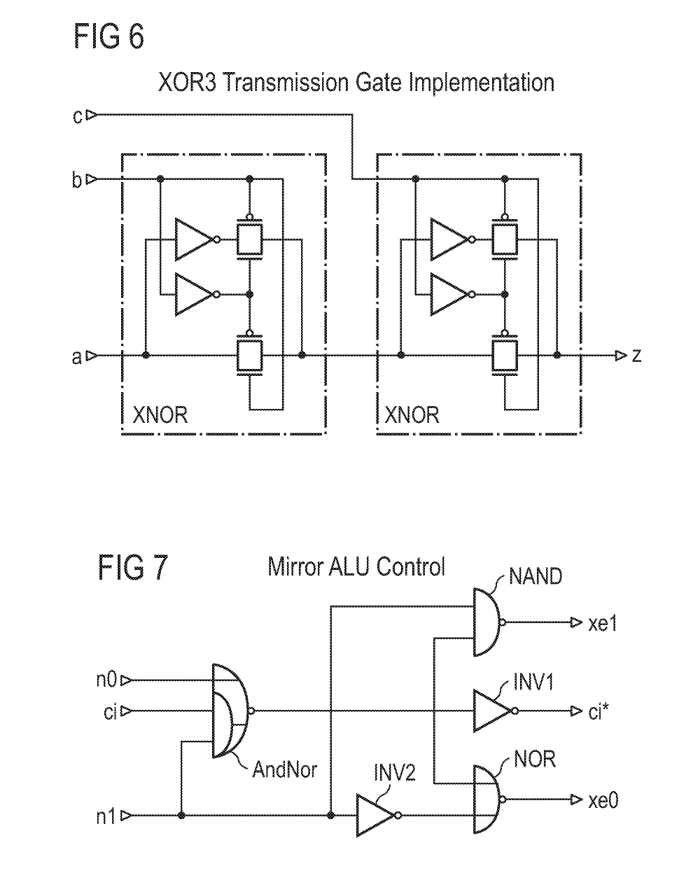

FIG. 6 illustrates an advantageous implementation of the XNOR3 circuit symbolically shown in FIG. 3, using the so-called “transmission gate” design style. From the “masked mirror ALU” cell according to the invention shown in FIGS. 2 to 4, it is easy to derive the variant of a “masked mirror ALU” cell without masking, that is to say, for k_{P}≡0∀p. The control logic, which is simplified in comparison to FIG. 3, is shown in FIG. 7.

What is claimed is:

1. A cell for arithmetic logic unit comprising:
a base unit operable to generate a masked inverted carry out bit co*_n and an inverted masked sum bit s*_n based on a first masked output a*, a second masked output b*, and a re-masked carry bit input ci*;
a transformation unit coupled to the base unit, the transformation unit having a first masked input bit aₖₐ, a second masked input bit b_{kb}, a first mask input bit ka, a second mask input bit kb, a third mask input bit ks, and a fourth mask input bit kp,
wherein the transformation unit is operable to generate the first masked output a* based on the first masked input bit aₖₐ, the first mask input bit ka, and the fourth mask input bit kp; the second masked output b* based on the second masked input bit b_{kb}, the second mask input bit kb, and fourth mask input bit kp; and a masked sum bit sₖ, based on the third mask input bit ks, the inverted masked sum bit s*_n, and the fourth mask input bit kp.

2. The cell of claim 1, wherein the first masked input bit aₖₐ is an input operand of a first input a masked with the first mask input bit ka.

3. The cell of claim 1, wherein the second masked input bit b_{kb} is an input operand of a second input b masked with the second mask input bit kb.

4. The cell of claim 1, wherein the masked sum bit sₖ, is an output operand of the inverted masked sum bit s*_n masked with the third mask input bit ks and the fourth mask input bit kp.

5. The cell of claim 1, wherein the third mask input bit ks is independent of the first mask input bit ka and a second mask input bit kb.

6. The cell of claim 1, wherein the first masked output a* is generated from a first XOR operation of the first masked input bit aₖₐ and a result of a second XOR operation of the first mask input bit ka and the fourth mask input bit kp.

7. The cell of claim 1, wherein the second masked output b* is generated from a first XOR operation of the second masked input bit b_{kB}, and a result of a second XOR operation of the second mask input bit kb, and fourth mask input bit kp.

8. The cell of claim 1, wherein the masked sum bit sₖₛ is generated from inverting a result of a first XOR operation of the inverted masked sum bit s*_n and a result of a second XOR operation of the third mask input bit ks and the fourth mask input bit kp.

9. The cell of claim 1, further comprising:
a control unit coupled to the base unit, the control unit is operable to generate the re-masked carry input bit ci*, a first control input xe0 and a second control input xe1 based on the first mask input bit kp, a second mask input bit kp-1, and a masked carry input bit ci′.

10. A transformation unit in an arithmetic logic unit cell comprising:
a first logic unit logically combining a first masked input bit aₖₐ with a mask input bit ka for the first masked input bit and a mask input bit for a certain bit position kp to form a first masked output a*;
a second logic unit logically combining a second masked input bit bₖₖ, with the mask input bit for a certain bit position kp and a mask input bit kb for the second masked input bit to form a second masked output b*; and
a third logic unit logically combining an inverted masked sum bit s*_n with the mask input bit kp for a certain bit position and a mask input bit ks for the masked sum bit to form a masked sum bit sₖₛ.

11. The transformation unit of claim 10, wherein the mask input bit ka for the first masked input bit is independent of the mask input bit kb for the second masked input bit.

12. The transformation unit of claim 10, wherein the mask input bit ks for the masked sum bit is independent of the mask input bit ka for the first masked input bit and the mask input bit kb for the second masked input bit.

13. The transformation unit of claim 10, wherein the mask input bit kp for a certain bit position is independent of the mask input bit ka for the first masked input bit, the mask input bit kb for the second masked input bit, and the mask bit input ks for the masked sum bit.

14. The transformation unit of claim 10, wherein the inverted masked sum bit s*_n is a logical combination of a first masked output a*, a second masked output b*, and a re-masked carry bit input ci* generated by a base unit coupled to the transformation unit.

15. A cell of an arithmetic logic unit of a certain bit position p comprising:
a control circuit being operable to generate a re-masked carry input bit ci*, a set of control inputs xe0, xe1 based on a mask input bit kp for a certain bit position, a mask input bit kp-1 for a previous bit position, a masked carry input bit ci′, and a set of control signals n0, n1;
a base circuit coupled to the control circuit, the base circuit being operable to receive a set of masked outputs a*, b*, and the re-masked carry bit input ci* and to generate an inverted masked carry out bit co*_n and an inverted masked sum bit s*_n; and
a transformation circuit coupled to the base circuit, the transformation circuit logically combining a set of masked inputs aₖₐ, b_{kb}, and the inverted masked sum bit s*_n with a corresponding set of mask input bits ka, kb, ks and the mask input bit kp for a certain bit position.

16. The cell of claim 15, wherein the transformation circuit is operable to logically combine the mask input bit kp for a certain bit position with a corresponding mask input bit ka for a first masked input, and a first masked input bit aₖₐ to generate a first masked output a*.

17. The cell of claim 15, wherein the transformation circuit is operable to logically combine the mask input bit kp for a certain bit position with a corresponding mask input bit kb for a second masked input, and a second masked input bit b_{kb} to generate a second masked output b*.

18. The cell of claim 15, wherein the transformation circuit is operable to logically combine the inverted masked sum bit s*_n, a corresponding mask input bit ks for the masked sum bit, and the mask input bit kp for a certain bit position to generate a masked sum bit sₖₛ.

19. The cell of claim 15, wherein the corresponding set of mask input bits ka, kb, ks are independent from one another.

20. The cell of claim 15, wherein the mask input bit kp for a certain bit position are independent from the corresponding set of mask input bits ka, kb, ks.
